(19) United States
(12) Patent Application Publication
(10) Pub. No.: US 2002/0102187 A1
(43) Pub. Date: Aug. 1, 2002

(54) Sectioned fragrance candle

(76) Inventors: Denise Dicharry Bellenger, Goode, VA (US); David J. Eisner, Richmond, VA (US); Charles I. Lunsford, North Garden, VA (US)

Correspondence Address: McGuire Woods, LLP, Suite 1800, 1750 Tysons Blvd., McLean, VA, 22102-4215, US

(21) Appl. No.: 09/769,768

(22) Filed: Jan. 26, 2001

(51) Int. Cl. B32B 5/02

(52) U.S. Cl. 422/126

(57) ABSTRACT

A sectioned fragrance candle that includes at least two wax containing vertical sections where at least two of the vertical sections have different fragrances is described. By lighting the appropriate wicks, the sectioned fragrance candle is able to produce individual fragrances or a blend of fragrances.

### FIELD OF THE INVENTION

The present invention is directed to a sectioned candle, and more particularly to a sectioned fragrance candle having vertical fragranced wax containing sections in one container.

### BACKGROUND OF THE INVENTION

There are a wide variety of fragrance candles where the candle wax is associated with a fragrance such as vanilla, cinnamon, or the like. Most fragrance candles have only one fragrance associated with each candle. This type of candle can only produce one scent at a time. In order to get a second, different scent, a second candle having a different scent must be burned.

There are types of fragrance candles that have more than one fragrance associated with a single candle. Typically these candles have horizontally positioned fragrance layers where each layer has a different fragrance. These types of candles can group a collection of fragrances together to contribute to a particular concept. For example, hot buttered rum, eggnog, and hot apple cider may be combined in a multiple horizontal layer candle to provide the concept of a Christmas holiday candle. As this type of candle burns, the first layer and scent is produced until the candle begins to burn into the second layer. At this point, a transitional fragrance is produced. The transitional fragrances are produced temporarily for a short period of time and are a combination of the scents from the first layer and the second layer. Once the candle has burned through the first layer and the transitional fragrance is over, the candle then takes on the scent of the second layer. This process is repeated for the number of layers provided in the layered fragrance candle.

The horizontally layered fragrance candle produces transitional fragrances for only a short period of time. Further, the user of the candle has very little control over the transitional fragrance. Additionally, the user of the candle cannot experience the transitional fragrances, or the scents in the second or third layer until the candle has burned through the necessary layers to produce those fragrances.

### SUMMARY OF THE INVENTION

An object of the present invention is to provide a sectioned fragrance candle in which the user controls which fragrances are burned at any given time.

Further, it is an object of the invention to provide a sectioned fragrance candle in which the user can control which transitional fragrances are produced at any given time.

Still further, it is an object of the present invention to provide a sectioned fragrance candle that includes multiple fragrance sections that can be burned individually or simultaneously.

Accordingly, the present invention includes a sectioned fragrance candle that includes a container for holding wax, where the container is divided into more than one vertical sections. Further, the sectioned fragrance candle includes wax having a fragrance contained in at least two of the more than one vertical sections, where at least two of the fragrances are different. The sectioned fragrance candle also includes a wick in each of the wax containing vertical sections.

The sectioned fragrance candle may be made of a material such as glass or ceramics. The number of vertical sections in the sectioned fragrance candle is preferably greater than 2. The number of vertical sections may be 3, 4, or more. The sectioned fragrance candle may also include a lid.

The container of the sectioned fragrance candle may be approximately cylindrical. Further, the container may taper from top to bottom. Still further, the container may be approximately cubical. The walls forming the vertical sections may be integrally formed with the container.

The present invention also includes a sectioned candle that comprises a container divided into more than one wax-containing vertical sections, where the wax in the wax containing vertical section has a color, and wherein at least two of the colors are different. The sectioned candle includes a wick in each of the wax-containing sections. The wax in the wax containing vertical section may have a fragrance. Further, at least two of the fragrances may be different.

### DESCRIPTION OF THE DRAWINGS

FIG. 1 is an isometric view of a sectioned fragranced candle in accordance with one embodiment of the present invention illustrated with a corresponding lid.

FIG. 2 is a front view of the candle illustrated in FIG. 1 without the lid.

FIG. 3 is a back view of the candle illustrated in FIG. 1 without the lid.

FIG. 4 is a top view of the candle illustrated in FIG. 1 without the lid.

FIG. 5 is a bottom view of the candle illustrated in FIG. 1.

FIG. 6 is an isometric view of a section fragranced candle in accordance with another embodiment of the present invention.

FIG. 7 is an isometric view of a section fragranced candle in accordance with still another embodiment of the present invention.

FIG. 8 is an isometric view of a section fragranced candle in accordance with yet another embodiment of the present invention.

### DETAILED DESCRIPTION OF THE INVENTION

The present invention is directed to a sectioned fragrance candle in which the user controls which fragrances will be burned at a given time. As will be discussed in detail below, the candle is made up of a container that is divided into more than one section. At least two sections are filled with a different fragranced wax. Each wax filled section also contains a wick for burning the wax in that particular section. Further, the invention is directed to a sectioned candle that has more that one vertical section filled with wax.

In one embodiment of the invention, each sectioned fragrance candle has more than one fragranced wax that is capable of being burned at a given time. In this way, a user may light one or more of the wicks in the sectioned candle to produce the desired effect. For example, a candle configured in accordance with the present invention may contain three sections where each section is filled with a different fragranced wax like vanilla, cinnamon, and blueberry. The user may light one or more of the wicks associated with these fragrances for the desired fragrances. The user may choose to create different fragrance combinations by lighting the vanilla and cinnamon only, the vanilla and blueberry only, the cinnamon and blueberry only, or all three simultaneously. As used herein, “a fragrance combination” is the fragrance produced when two or more different fragranced waxes are burned simultaneously. A sectioned candle in accordance with the present invention provides functionality that is not achieved in single scent candles or multi-fragrance candles that have horizontal fragrance layers.

The sectioned fragrance candle of the present invention allows a user to control a plurality of distinct fragrances from a single container. For example, a sectioned fragrance candle that has three sections, where each section is filled with a different fragrance wax allows a user to produce 7 distinct fragrances and fragrance combinations. As the number of sections in the container increases, the number of distinct fragrance and fragrance combinations increases.

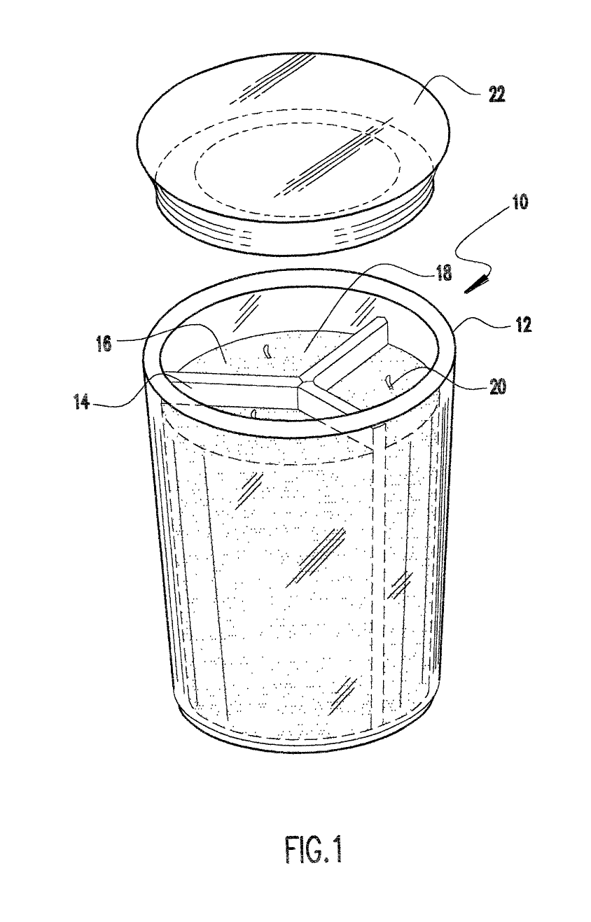

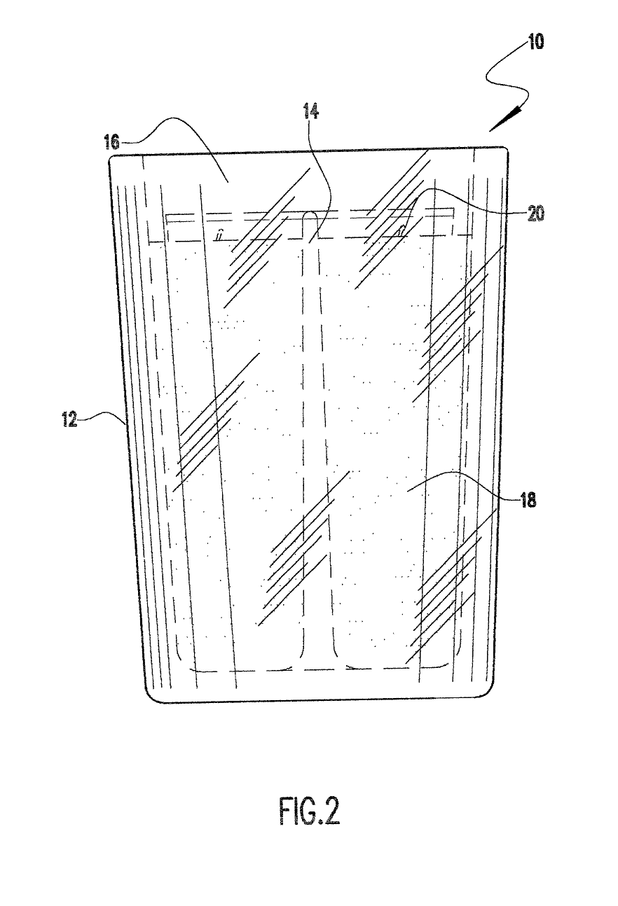

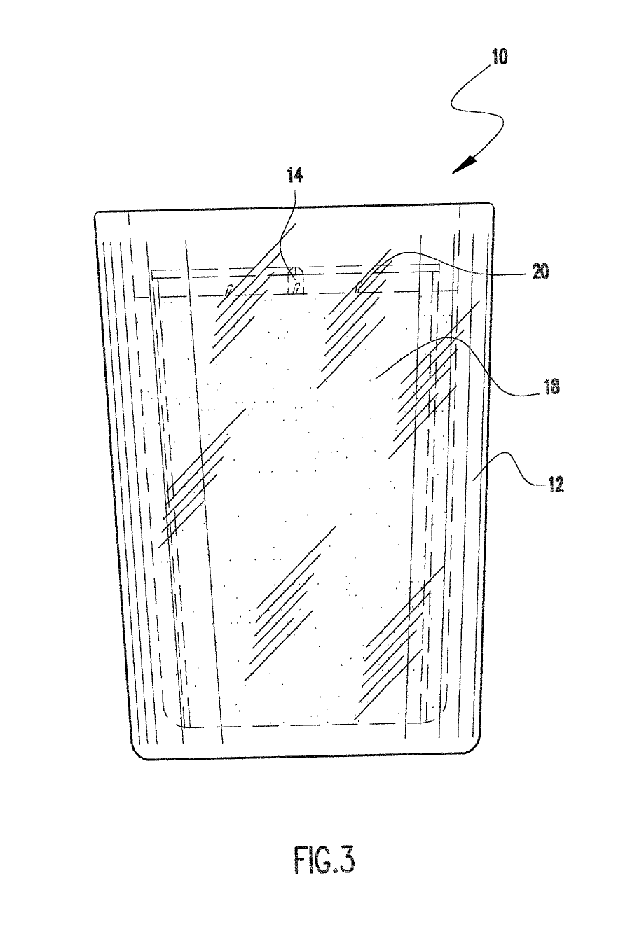

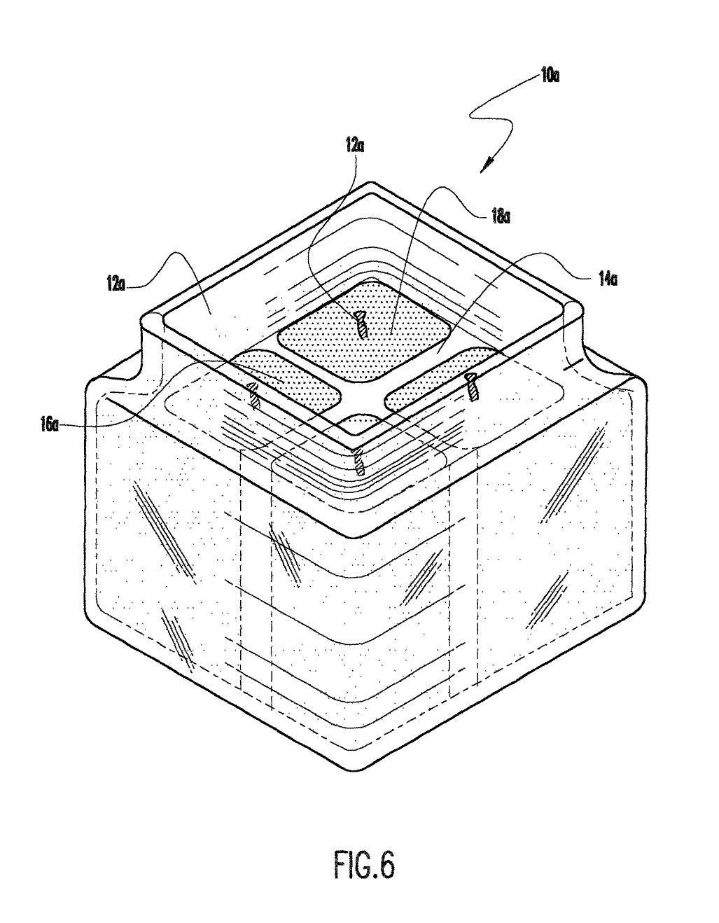

The present invention will be discussed in detail with respect to one embodiment illustrated in FIGS. 1 through 5. In these Figures, there is shown a sectioned fragrance candle designated generally by the reference numeral 10. The candle is made up of a container 12 that has interior walls 14, which divide the interior portion of the container into sections 16. The size of the container 12 is not crucial and can take on a wide variety of shapes and sizes. Typical sizes for the glass container 12 range from about 10 ounces to about 36 ounces. It will be appreciated that the size of the glass container 12 may be much larger or much smaller than the typical range. Further, the container 12 may contain a lid 22 for the opening of the container 12. The shape of the container 12 may be approximately cylindrical tapering from top to bottom as illustrated in FIG. 1. The container 12 may be made from any material suitable for holding and burning candle wax. Preferably, the container 12 is made of glass or ceramic material.

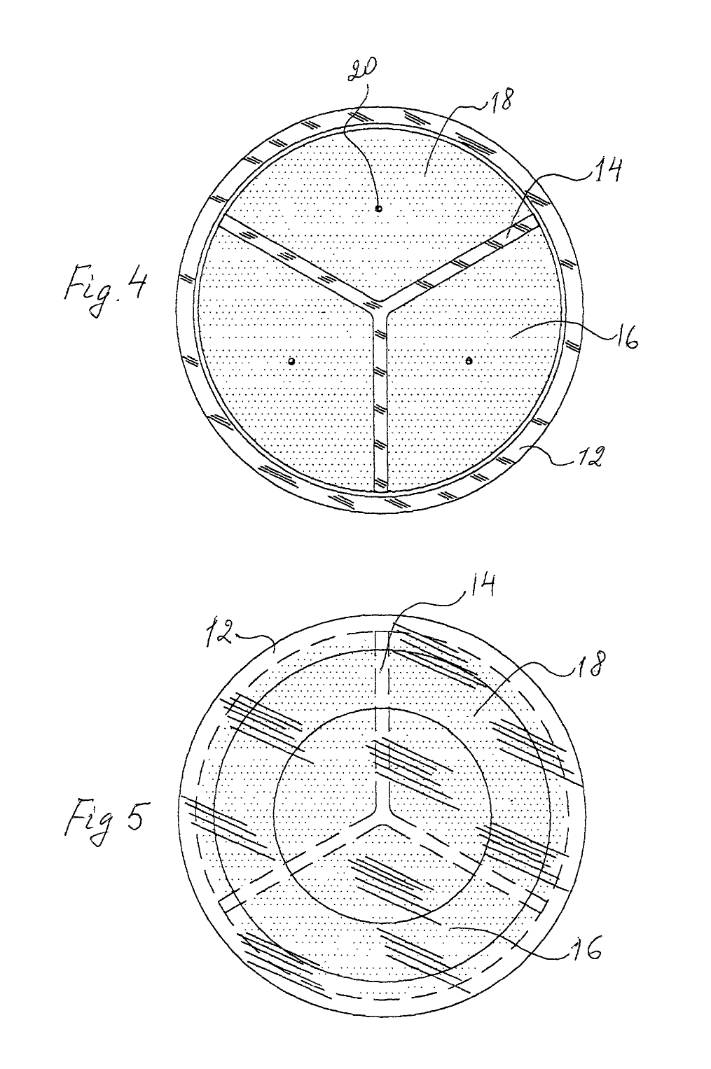

The interior walls 14 that divide the interior portion of the container 12 into sections 16 may take on a variety of configurations. Preferably, the sections 16 are approximately vertical, extending from the bottom of the candle to the top of the candle. The interior walls 14 may divide the interior portion of the container 12 into equal sections 16. Alternatively, the interior walls 14 may divide the interior portion into unequal sections. The interior walls 14 may extend radially from the center of the container 12 and divide the interior into pie shaped sections as illustrated in FIG. 4. Alternatively, the interior walls 14 may be perpendicular with one another creating an even number of sections 16 as illustrated in FIG. 6.

The number of the sections 16 created by the interior walls 14 and the space and configuration of these sections is virtually unlimited. The size and shape of the container may limit the number, size, and shape of the sections 16. What is important is that the interior portion of the container 12 is divided up into at least two sections 16. The container 12 may be divided into 3, 4, or more sections 16.

The interior walls 14 and the container 12 may be constructed out of the same or different materials. Further, the interior walls 14 may be integrally formed with the container 12.

The container 12 may be made according to those method well know to one skilled in the art. Preferably, the container 12 may be made using a mold or die. The interior walls 14 may be incorporated in the mold or die. Alternatively, the interior walls 14 may be made separate from the container 12.

At least two of the sections 16 contain fragranced wax 18. A wick 20 is provided for each section 16 containing wax 18. In order to be able to produce a fragrance combination, the fragranced wax in two of the sections 16 should have different fragrances. If the container 12 has more than two sections 16, some of the sections 16 may contain fragranced wax, while other sections may contain decorative items such as colored stones, beads, figurines, or other similar items. For example, in a container having three sections, one section may be filled with wax having one fragrance, another section may be filled with a wax having a second fragrance, and the third section may be left empty or may contain decorative items such as beads or other items providing decorative features to the candle.

The decorative items may correspond to a theme for the sectioned candle. For example, a sectioned fragrance candle that has a Christmas holiday theme may include one section that contains hot buttered rum fragranced wax, a second section may contain hot apple cider fragranced wax, and a third section may contain decorative items such as red and green colored stones or a Christmas figurine.

Any wax suitable for candles may be used with the present invention. Preferably, for visual presentation, a color is added to the wax. The color may be a color that complements the fragrance or the particular theme of the candle. For example, a blueberry scent may be associated with a dark blue color. A red color may be associated with a Christmas candle or a cinnamon fragrance.

The fragranced wax may be added to the sections 16 of the container 12 during manufacturing. Preferably, the fragranced wax is heated and poured into the desired section 16 of a container 12. Alternatively, the wax may be in the form of inserts that correspond to the size and shape of the sections 16. In this way the user of the candle may configure the candle for the desired fragrances by choosing which fragranced wax to add to the sections. Further, the fragrances may include, but is not limited to those fragrances known and currently used to make scented candles, fragrances used for aroma therapy, and those fragrances that impart a scent or odor when the wax is burned.

While the sectioned fragrance candle has been described in detail and one particular embodiment has been illustrated in FIGS. 1-5, other exemplary embodiments of the present invention are illustrated in FIGS. 6-8. These embodiments are provided for illustration purposes and should not be construed as limiting the scope of the present invention.

FIG. 6 illustrates a sectioned candle in accordance with another embodiment of the present invention designated generally by the reference numeral 10a. The container 12a is approximately cubical and may have an opening that is narrower than the body of the container. The opening illustrated in FIG. 6 does not have to be narrower than the body. The opening could have the same dimensions as the body of the container. The relative dimensions of the container 12a are not critical and may take on a variety of dimensions. The container 12a has interior walls 14a extending vertically from the bottom of the container 12a, which divide the interior portion of the container into sections 16a. Wax 18a is contained in the sections 16a. A wick 20a is provided for each wax containing section.

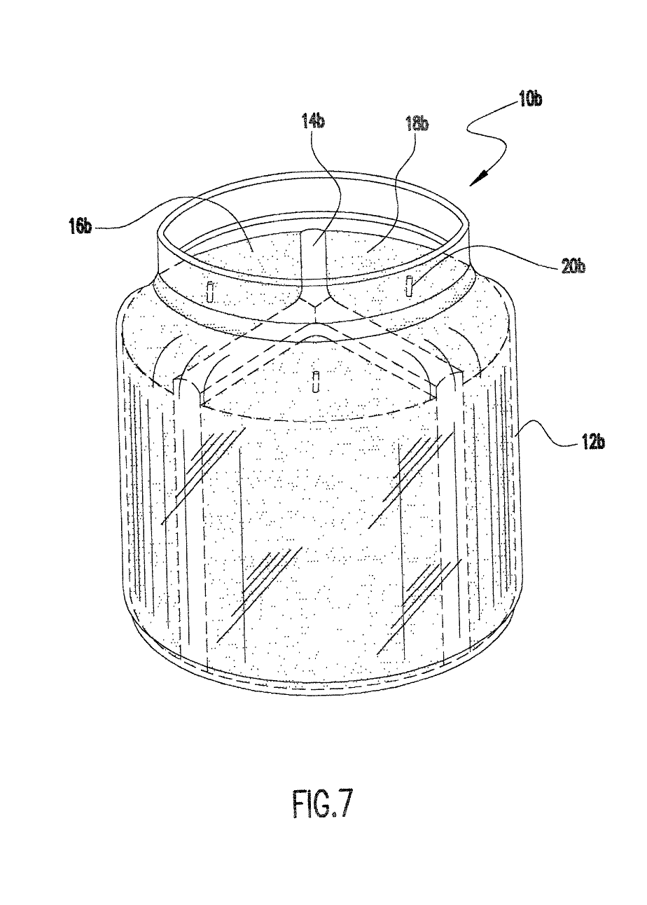

FIG. 7 illustrates a sectioned candle in accordance with another embodiment of the present invention, designated generally by the reference numeral 10b. The container 12b is approximately cylindrical and may have an opening that is narrower than the body of the container. The opening illustrated in FIG. 7 does not have to be narrower than the body. The opening could have the same dimensions as the body of the container. The relative dimensions of the container 12b are not critical and may take on a variety of dimensions. The container 12b has interior walls 14b extending vertically from the bottom of the container 12b, which divide the interior portion of the container into sections 16b. Wax 18b may be contained in the sections 16b. A wick 20b is provided for each wax containing section.

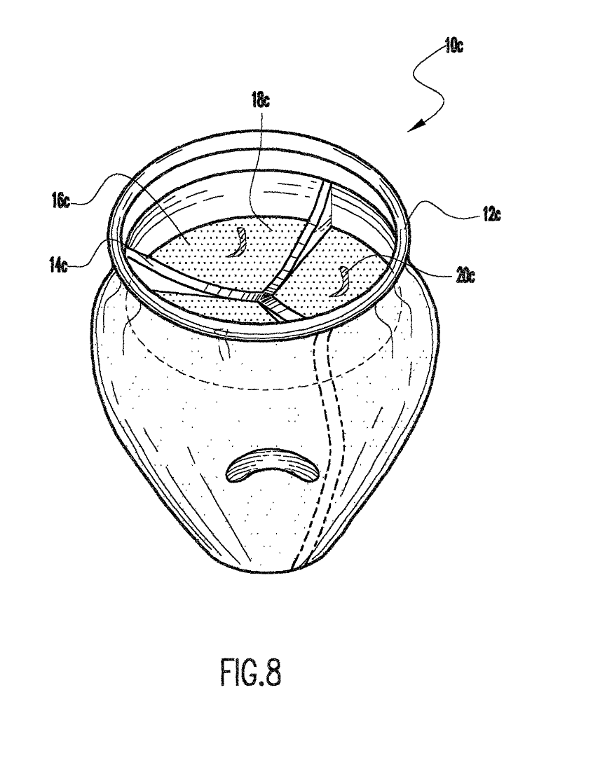

Another embodiment of the present invention is illustrated in FIG. 8. FIG. 8 illustrates a sectioned candle in accordance with the present invention designated generally by the reference numeral 10c. The shape of the container 12c is similar to that of a vase. The relative dimensions of the container 12c are not critical and may take on a variety of dimensions. The container 12c has interior walls 14c extending vertically from the bottom of the container 12c, which divide the interior portion of the container into sections 16c. The interior walls 14c, as illustrated in FIG. 8, extend radially from the center of the container 12c. In one embodiment, the height of the walls 14c increases as the wall extend radially from the center of the container 12c. Wax 18c is preferably contained in at least two of the sections 16c. A wick 20c is provided for each wax containing section.

The variations of the container, interior wall, sections, wax and lid as discussed with above with respect to the embodiment illustrated in FIGS. 1-5 are applicable to the embodiments illustrated in FIGS. 6-8.

A sectioned fragrance candle in accordance with the present invention allows the user of the candle to select which fragrances and fragrance combinations are burned at any given time. Further, the candle of the present invention allows the user to burn fragrance combinations at any given time by lighting two or more of the wicks associated with different fragrances. In contrast to fragrance candles with horizontal layers, the user does not have to wait for the wick to burn through layers of wax to produce a fragrance combination or to experience the scent of the second fragrance. Further, fragrance combinations that were only produced for limited times in horizontal layered fragrance candles may now be produced at any time by lighting the appropriate wicks associated with the different fragrances.

Another embodiment of the present invention is directed to a sectioned candle that has more than one vertical section filled with different colored wax. This embodiment is similar to those previously described for the sectioned fragrance candle and illustrated in FIGS. 1-8, except that the wax may or may not have a fragrance. Preferably, the color of the wax in at least two of the vertical sections is different. Further, the wax in each of the vertical sections may be at different heights. Preferably, the container is made of glass such that the colored wax is visible through the walls of the container. The characteristics and materials of the container and interior walls are the same as that described for the sectioned fragrance candle.

It will be readily understood by those persons skilled in the art that the present invention is susceptible to broad utility and application. Many embodiments and adaptations of the present invention other than those herein described, as well as many variations, modifications and equivalent arrangement, will be apparent from or reasonably suggested by the present invention and the foregoing description without departing from the substance or scope of the present invention.

Accordingly, while the present invention has been described in detail in relation to its preferred embodiment, it is to be understood that this disclosure is only illustrative and exemplary of the present invention and is made merely for purposes of providing a full and enabling disclosure of the invention. The foregoing disclosure is not intended to be construed to limit the present invention or otherwise exclude any other embodiments, adaptations, variations, modifications or equivalent arrangements, the present invention being limited only by the claims and the equivalents thereof.

What is claimed is:

1. A sectioned fragrance candle comprising:
a container for holding wax, wherein the container is divided into more than one vertical sections;
wax having a fragrance contained in at least two of said more than one vertical sections, wherein at least two of the fragrances are different; and
a wick in each of said vertical sections containing wax.

2. The candle of claim 1 wherein the container is made of a material selected from the group consisting of glass and ceramics.

3. The sectioned fragrance candle of claim 1 wherein the container is made of glass.

4. The sectioned fragrance candle of claim 1 wherein the number of vertical sections is greater than 2.

5. The sectioned fragrance candle of claim 1 wherein the number of vertical sections is 3.

6. The sectioned fragrance candle of claim 1 wherein the number of sections is 4.

7. The sectioned fragrance candle of claim 1 wherein the candle further comprises a lid.

8. The sectioned fragrance candle of claim 1 wherein the container is approximately cylindrical and tapers from top to bottom.

9. The sectioned fragrance candle of claim 1 wherein the container is approximately cubical.

10. The sectioned fragrance candle of claim 1 wherein the walls forming the sections are integrally formed with the container.

11. The sectioned fragrance candle of claim 1 wherein the walls forming the sections are removable inserts.

12. A sectioned candle comprising:
a container divided into more than one wax-containing vertical sections, wherein the wax in the wax containing vertical section has a color, and wherein at least two of the colors are different; and
a wick in each of the wax-containing sections.

13. The sectioned candle of claim 12 wherein the wax in the wax containing vertical section has a fragrance.

14. The sectioned candle of claim 13 wherein at least two of the fragrances are different.

15. The sectioned candle of claim 12 wherein the container is made of glass.
